(19) United States
(12) Patent Application Publication
(10) Pub. No.: US 2003/0076605 A1
(43) Pub. Date: Apr. 24, 2003

(54) Single unit two-sided mirror

(75) Inventor: Gavriel Shohet, Brookline, MA (US)

Correspondence Address: BANNER & WITCOFF, LTD., 28 STATE STREET, 28th FLOOR, BOSTON, MA, 02109, US

(73) Assignee: Dr. Gavriel Shohet, Brookline, MA

(21) Appl. No.: 10/175,121

(22) Filed: Jun. 19, 2002

Related U.S. Application Data
(60) Provisional application No. 60/338,951, filed on Oct. 22, 2001.

(51) Int. Cl. G02B 5/08

(52) U.S. Cl. 359/840; 359/882

(57) ABSTRACT

A novel mirror comprising a handle portion unitary with a mirror-head portion including reflective or mirror surfaces on opposing surfaces of the mirror-head portion is disclosed. The mirror includes an anti-fog material coated onto the mirror surfaces to prevent the formation of condensation on the mirror surfaces. The mirror may include an indicator to inform an operator that the mirror has been used and should be disposed of appropriately. The mirror is disposable, can be prepackaged and/or presterilized to provide better results and a predictably cleaner instrument, and can be designed to prevent use of the mirror on more than a single subject.

### FIELD OF INVENTION

The present invention relates to a single unit two-sided mirror. More particularly, the invention relates to a hand-held single unit two-sided mirror suitable for use in oral examination, oral surgery and other dental procedures. This application claims the benefit of U.S. Provisional patent application No. 60/338,951 entitled Single Unit Two-Sided Mirror filed on Oct. 22, 2001.

### BACKGROUND

Hand-held mirrors are used for viewing different areas of the mouth and teeth during dental procedures. For example, U.S. Pat. No. 3,162,191 discloses an oral examiner having a plurality of longitudinal slots in the body and is designed to function as a tongue depressor, a retractor, and a laryngeal mirror. U.S. Pat. No. 3,512,259 discloses a dental mouth examining mirror having a rigid stem molded from synthetic resin which has a lower coefficient of thermal conductivity than metal or glass. U.S. Pat. No. 3,829,199 discloses a dental mirror comprising a shank and a mirror releasably attached at one end thereto, with a cooperating means for locking the mirror and the shank to one another. U.S. Pat. No. 4,512,635 discloses a dental mirror apparatus having a handle, a mirror means, a holder means and rim for holding the mirror to the handle, and a plurality of faces on an inner periphery. U.S. Pat. No. 4,931,015 discloses a mirror for dental care comprising a handle, a mounting and a glass or reflective insert, the mounting being removably mounted to the handle and the glass or reflective insert is removably mounted to the mounting. U.S. Pat. No. 6,068,379 discloses an inspection mirror having a transparent substrate, a metallization layer, and a first and second reflecting surface that are spaced by less than 0.010 inches. U.S. Pat. No. 6,142,777 discloses a disposable dental mirror having a handle in the form of a flat elongated blade of substantially equal thickness with a flexible, plastic reflective film attached to the top surface of the blade.

Many dental mirrors currently in use are manufactured from metals that are capable of withstanding the chemicals and conditions used to sterilize the mirrors. Materials, such as rhodium, can withstand chemical and mechanical stresses but in many instances provide inferior reflective surfaces than other materials. The mirror surface typically is also susceptible to fogging when placed into a subject's mouth. Many mirrors currently in use have a relatively short handle, which may not provide for easy grasping and/or positioning the mirror. In view of the disadvantageous characteristics of known dental mirrors, there exists a need in the art for improved devices suitable for use as dental mirrors. It is an object of the present invention to provide improved mirror devices suitable for use as dental mirrors. It is a particular object of certain preferred embodiments to provide a single unit two-sided dental mirror that is simple and inexpensive to manufacture and is disposable.

### SUMMARY

In accordance with a first aspect, a single unit two-sided mirror is provided comprising a handle portion and a mirror-head portion having substantially planar opposite first and second faces with reflective material on each of the faces. The reflective material is “on” the faces of the mirror-head portion such that the reflective material is disposed, deposited, coated, attached, fixed, glued, soldered, welded, etc., directly or indirectly, to the first and second faces of the mirror-head portion. The mirror surfaces preferably are flat or of optical quality, most preferably being, for example, suitable for use as a dental mirror. That is, the mirror surfaces are distortion free such that good reflective surfaces are provided. The handle portion and mirror-head portion are unitary, i.e. continuous without any joints connecting the handle-portion and mirror-head portion, e.g. the handle portion and the mirror-head portion can be a single piece of plastic. The handle portion and the mirror-head portion preferably are manufactured as a single continuous unit. Alternatively, separately molded parts can be unitized, e.g. by solvent welding or the like. Reference to the mirrors disclosed here as being “hand-held” means that they are suitably sized, weighted and configured to be held in a person's hand during use, and to be manipulated by hand or digitally, i.e. with the fingers, or manually placed into position. That is, the mirror may be hand-held during an entire procedure or may be manually positioned for a procedure but not held by the operator's hands during the procedure. Thus, the position and orientation of the mirror-head portion within the mouth of a patient, in the case of preferred embodiments suitable for use as dental mirrors, for example, can be readily controlled by hand during use in a dental procedure. Reference to the mirrors disclosed here as being “two-sided” means that the mirror-head portion comprises opposing surfaces that are coated with reflective material. In certain embodiments, the mirror head has at least two major mirror surfaces, i.e., a first mirror surface, e.g., one of the two large surfaces of a disk-like mirror-head, oriented at an angle to the longitudinal axis of the elongate shaft as discussed in more detail elsewhere in this specification, and at least one more major mirror surface facing in a direction substantially different from that of the first mirror surface, e.g., a mirror surface on the second side of such disk-like mirror-head, facing in the substantially opposite direction from the first surface. After the examination or procedure is completed on the subject, the mirror is disposed of using standard accepted waste disposal procedures or otherwise discarded. That is, the mirror preferably is a single-use mirror. As used here, single-use means use of the mirror on a single patient or subject. Suitable manufacturing techniques will be apparent to those skilled in the art given the benefit of this disclosure. Exemplary manufacturing techniques are discussed below. For example, it is possible to manufacture the dental mirror as a single elongate, cylindrically-shaped member where one end of the member is subsequently flattened and bent to form the support structure for the mirror surfaces while the other end remains substantially elongate to form the handle-portion of the mirror.

In accordance with a second aspect, the handle portion typically comprises an elongate shaft. The elongate shaft may have a circular cross-section, or other geometric cross-section suitable for manual manipulation of the mirror. The elongate shaft of the handle portion of the hand-held two-sided mirrors disclosed here can be straight or curved, rigid or flexible, smooth or contoured. The handle portion of the mirror may consist only of the elongate shaft; e.g., as in the preferred embodiments shown in the appended drawings. The shaft should be long enough to facilitate manual manipulation, i.e., controlling the position and orientation of the mirror-head portion by hand or fingers. Preferably, the shaft portion is at least about 4-8 inches long, more preferably about 5-7 inches long, most preferably at least about 5-6 inches long, e.g., about 6 inches long. As used here., the term “flexible” means that the shaft can be non-destructively bent from its free state, i.e., its natural or original configuration, preferably through any angle desired by a user. In certain configurations, the handle portion comprises a lightweight material that is cheap, inexpensive and disposable, and optionally biodegradable. For example, the handle portion can be manufactured from plastics, rubbers, ceramics, paper-based materials, such as paper-based materials having a fluid-resistant coating, e.g. a waterproof coating, moldable materials, flexible materials, such as bendable plastics, bendable rubbers and the like. One skilled in the art given the benefit of this disclosure will be able to select materials, geometries, lengths, widths, etc., for the handle portion suitable for an intended use.

In accordance with another aspect, the handle portion is designed to provide an ergonomic grip to the user. That is, in certain preferred embodiments of the single unit two-sided mirrors disclosed here, the elongate shaft of the handle portion has one or more ergonomic features, that is, configuration, surface texture, and/or other features different from a smooth-surfaced rod. In particular, such ergonomic features may include, for example, rough surface portions, such as rough surfaced indents sized and positioned along the shaft to receive the user's fingertips for manipulation of the position and orientation of the mirror-head portion. In addition, the elongate shaft may have a cross-section that tapers toward the free end, i.e., the end opposite the mirror-head portion. The elongate shaft in certain embodiments has a non-circular cross-sectional shape, e.g., a square, oval, triangular or irregular shape along some or all of its length. Other ergonomic features will be apparent to those skilled in the art given the benefit of this disclosure.

It is a significant benefit of the single unit two-sided mirrors disclosed here, that the mirror-head portion and the elongate shaft portion are a unitary body, that is, a one-piece structure. Numerous suitable materials and manufacturing techniques are known, whose use in forming preferred embodiments of the hand-held two-sided mirrors will be readily apparent in view of the present disclosure. It is a further significant advantage, that a number of these applicable and cost-effective materials and manufacturing techniques are suitable for simultaneously forming the aforesaid ergonomic features in the elongate shaft. In certain preferred embodiments, the one-piece structure comprising the mirror-head portion and the elongate shaft are molded of metal, plastic or ceramic. Preferably, the units are molded of rigid or flexible plastic, and such ergonomic features are formed in the shaft as it is molded. As used here, the term “flexible plastic” refers to any polymeric material that permits the single unit two-sided mirror to be nondestructively bent from its free state, i.e., its natural or original configuration, preferably through any angle desired by a user. In this way, single unit two-sided mirrors as disclosed here are produced efficiently and cost effectively. Suitable molding methods include, for example, injection molding, reaction injection molding, press-forming and the like. Optionally, inserts are molded into the unit, such as reinforcement members, e.g. fibers, or the like. Such inserts may be either partially or entirely embedded in the one-piece unit comprising the mirror-head portion and the elongate shaft.

In accordance with highly preferred embodiments of the single unit two-sided mirrors disclosed here, the finished unit is a dental mirror formed as a one-piece molded plastic unit comprising the mirror-head portion and the elongate shaft unitary with each other. The elongate shaft has molded-in ergonomic features and is at least about 5 inches long. The mirror-head portion is round or oval and substantially planar, the first and second mirror faces being formed by reflective material coated onto at least the two opposite major faces, and more preferably being parts of the same all-over coating that covers the major faces and the peripheral or edge surface of the mirror-head portion. Substantial cost savings can be realized in such rimless embodiments of the hand-held two-sided dental mirrors. Such preferred embodiments, in some cases, can be produced at sufficiently low-cost to be disposable, i.e., single-use, thereby saving the cost and complexity of sterilization after use. Prior known mirrors employing rims to hold one or two mirrors to a mirror-head portion typically are more complex and expensive to produce.

In accordance with another aspect, the mirror-head portion preferably forms a direct mirror support structure with a mirror coating or mirror surface, e.g. a reflective material, on both faces of the mirror support structure. That is, the mirror-head portion preferably has a first mirror surface on a first face and a second mirror surface on a second face that is opposite the first mirror surface. In such embodiments, the reflective material forming the mirror surfaces is on the faces of the mirror head portion preferably as an all-over sputter coating, dip-coating, or the like. The mirror surface on both sides of the mirror-head portion typically increases the overall light levels within a subject's mouth.

In accordance with additional aspects, the mirror support structure preferably comprises the same material as the handle portion. That is, the mirror support structure may comprise plastics, rubbers, ceramics, paper-based materials, such as paper-based materials having a fluid-resistant coating, e.g. a waterproof coating, moldable materials and flexible materials, such as bendable plastics, bendable rubbers and the like, but preferably comprises the same material as the handle portion to facilitate rapid manufacture of the dental mirror. In certain configurations, the material comprising the mirror support structure is preferably malleable. That is, the material comprising the mirror support structure is capable of being flattened or shaped under certain conditions, such as high temperature and/or high pressure for example, to obtain a desired geometry and/or size for the mirror support structure. For example, high temperature may be used to soften a portion of the dental mirror such that the softened portion may be shaped into a desired configuration for the mirror support structure, e.g. a flat disc. In other configurations, depressions may be introduced into the mirror support structure such that subsequent deposition, or attachment, of a reflective material, e.g. a mirror-like substance, creates a concave mirror on one side or face of the mirror support structure and a convex mirror on the other side or face of the mirror support structure. Alternatively, depressions or protrusions may be introduced such that concave mirrors or convex mirrors, respectively, are created on both sides or faces of the mirror support structure after deposition, or attachment, of a mirror surface.

In accordance with other aspects, the mirror support structure is rimless to maximize the amount of area for receiving the reflective film or coating. One skilled in the art, given the benefit of this disclosure, will be able to select suitable mirrors and/or mirror support structures for incorporation into the mirrors described here. The mirror-head portion is preferably, but not necessarily, substantially planar, having a uniform or non-uniform thickness between the mirror faces, i.e., between the aforesaid substantially planar first face and substantially planar second face of the mirror-head portion. Preferably, the mirror-head portion has the configuration of a thin, round wafer or disc, although, as discussed further below, the mirror-head portion can have any shape suitable to an intended use, e.g., round, triangular, square, oval or irregular. As used here, the terms “substantially planar first face” and “substantially planar second face” refer to mirrored major surfaces of the mirror-head portion, e.g., the two opposite fiat surfaces of a disk-shaped mirror-head portion rather than the thin peripheral or edge surface between them, which surfaces are sufficiently planar for their intended use as a mirror. The first and second faces preferably are substantially oppositely facing, and need not be exactly oppositely facing. Optionally, one or both can be curvo-planar, i.e., non-flat, e.g., concave, convex or otherwise configured to provide mirror effect useful to the intended purpose, e.g., enlargement, etc. The substantially planar first face and the substantially planar second face each has reflective material on it. Optionally, for example, each has a mirror, e.g. a mirror coated glass or plastic wafer or disc, glued or otherwise attached. Alternatively, as noted above, reflective material can be coated or otherwise disposed directly on the first and second faces of the mirror-head portion. As used here, reflective material is deposited or coated directly on the mirror-head faces when no supplemental substrate is employed, such as a glass or plastic wafer, disc, or the like carrying the reflective material and adhered to the mirror-head portion. Reflective material can be directly disposed on the faces of the mirror-head portion by any of numerous known techniques, whose application to the single unit two-sided mirror disclosed here will be readily apparent to those skilled in the art given the benefit of this disclosure, including, for example, vapor deposition, dip-coating or painting, etc. Other suitable direct coating will be apparent given the benefit of this disclosure. Optionally, the first mirror surface and the second mirror surface are unitary with each other, being portions of an all-over mirror coating on the mirror-head portion, e.g. enveloping all surfaces of the mirror-head portion. For example, the mirror-head portion can be dip-coated in a reflective material, e.g., reflective paint or the like, or exposed to vapor deposition, e.g., physical or chemical vapor deposition of a thin-film reflective coating, optionally without masking peripheral or edge surfaces of the mirror-head portion.

In accordance with additional aspects, the longitudinal axis of the mirror-head portion is preferably positioned at an angle with respect to the longitudinal axis of the handle portion. Such mirror head angles typically depend in part on the intended use of the dental mirror. In certain configurations, the angle between the longitudinal axis of the mirror-head portion and the handle portion is less than 90°, whereas in other configurations the angle between longitudinal axis of the mirror-head portion and the longitudinal axis of the handle-portion is obtuse, i.e. greater than 90° and less than 180°. One skilled in the art given the benefit of this disclosure will be able to select mirror head angles suitable for an intended use. In certain configurations, the angle may be adjusted, e.g. by bending the mirror-head portion, to an angle suitable for viewing desired structures or features within a subject's mouth. As stated above, the first mirror surface of the mirror-head portion of the hand-held two-sided mirrors disclosed here are at an angle to the longitudinal axis of the shaft portion. This should be understood to mean that the first mirror surface lies generally in a plane that is at an angle to the longitudinal axis of the shaft portion. Reference here to the mirror surface lying generally in a plane that is at an angle to the longitudinal axis of the shaft of the handle portion should be understood to mean that the longitudinal axis does not lie in such plane and is not parallel to such plane. Preferably, the axis intersects the plane at an obtuse angle, i.e., an angle greater than 90° and less than 180°. More preferably the angle is between 120° and 180°, most preferably at an angle between 150° and 170°, such as an angle of about 160°-170°. In typical preferred embodiments, wherein the mirror-head portion is substantially planar, the first and second mirror surfaces being substantially parallel to each other, the entire mirror-head portion lies generally in a plane at an angle to the longitudinal axis of the shaft portion.

In accordance with another aspect, the mirror surface of the mirror-head portions may be created by deposition of suitable reflective materials onto both sides of the mirror support structure. That is, suitable reflective materials, such as rhodium, silver, aluminum, titanium, and other reflective metals may be deposited onto the mirror support structure. Deposition can be accomplished in a rapid manner because it is not necessary to ensure that deposition of the mirror surface occurs only on the mirror support structure. That is, if small amounts of reflective materials are deposited onto the elongate shaft of the mirror, the mirror will still be operative. A reflective material may be applied to the mirror support structure manually, e.g. by brushing the coating onto the surfaces of the mirror support structure, or may be applied by a vapor deposition process, such as directed vapor deposition (DVD), chemical vapor deposition (CVD), and the like. Preferably a minimal amount of material is deposited to create the mirror surfaces of the mirror-head portion. Alternatively, the mirror surfaces are disposed on the mirror-head portion by the dipping the mirror-head portion, i.e. completely immersing the mirror-head portion, into a reflective material that provides a mirror finish. In certain configurations, mirrors may be attached, e.g. glued or fixed, to the mirror support structure to provide the mirror surfaces of the mirror-head portion. In other configurations, reflective plastic films may be attached to each side of the mirror support structure to provide mirror surfaces. One skilled in the art given the benefit of this disclosure will be able to select suitable films and coatings for deposition on or attachment to the mirror-head portion to create mirror surfaces on each face of the mirror-head portion. Preferably, the mirror materials are chosen based on their mirror quality, cost, and the intended use of the mirror.

In accordance with additional aspects, preferably the mirror surfaces are coated with an anti-fog or anti-mist material, film, or coating to prevent build-up of unwanted condensation on the mirror surfaces. Suitable anti-fog materials, films, and coatings are described in U.S. Pat. No. 5,780,148, U.S. Pat. No. 5,148,311, U.S. Pat. No. 4,080,476 and U.S. Pat. No. 3,933,407, the entire disclosure of each of which is hereby incorporated by reference for all purposes. The anti-fog coatings may be hydrophobic, hydrophilic or both. Anti-fogging agents are available from numerous manufacturers including but not limited to Exxene (Corpus Christi, Tex.), which manufactures Exxene anti-fog coatings such as HTAS 108, and Film Specialties Inc. (Belle Meade, N.J.), which manufactures FSI-86, a low-cost anti-fog film, and Vistex®t anti-fog film optionally having a pressure sensitive adhesive on the reverse side. One skilled in the art given the benefit of this disclosure will be able to select anti-fog materials, films and coatings suitable for preventing fogging, misting and moisture build up on the mirror surfaces. Anti-fogging coatings can be bonded to the mirror surfaces and can be applied in different ways, e.g. brushing, depositing, etc. Clear sealants may be disposed on the antifog coating and/or mirror surfaces if desired. Suitable clear sealants will be readily apparent to those skilled in the art given the benefit of this disclosure. Other coatings, such as scratch-resistant coatings, anti-ultraviolet coatings, anti-static coatings, etc. may also be applied to the mirror surfaces and/or the handle of the mirror described here.

In accordance with another aspect, the dental mirror may optionally comprise one or more indicators operative to sense oral conditions. As used here oral conditions means the temperature, moisture levels, e.g. humidity levels, etc., in or near the mouth of a subject. Alternatively, an indicator that is operative to change states or conditions in response to grasping of the shaft and/or mirror head can be disposed on the mirror. For example, prior to placing the dental mirror in the mouth of a subject, the indicator is at an initial state, which informs an operator, e.g. a dentist, that the dental mirror has not been placed into or near any subject's mouth. When an operator uses the dental mirror, the indicator changes from its initial condition or state to a final condition or state after sensing one or more oral conditions. For example, the indicator may include a temperature strip that changes from a first color, e.g. white, to a second color, e.g. black, after being placed into the mouth of a subject. That is, the temperature strip may be operative to change color at a temperature equal to or greater than about 37° C. or higher. Preferably this color change is irreversible so as to provide an indication that the dental mirror has been used and should be disposed of. In other configurations, the indicator comprises a humidity sensor that changes color in response to the high moisture conditions present in a subject's mouth. The indicator may be positioned at any location along the handle provided that the portion of the handle comprising the indicator is placed into or near a subject's mouth. The indicator may be attached using an adhesive, tape, and the like. Preferably the indicator is positioned near the mirror-head portion but does not preclude viewing of the mirror surface by an operator. One skilled in the art given the benefit of this disclosure will be able to select indicators and positions for attachment of those indicators.

In accordance with a method aspect, the mirrors can be manufactured from a die or mold that receives the materials which will form the mirror, e.g. plastic injection molding can be used to manufacture the mirrors disclosed here. For example, a metal substrate having a mold shaped in the form of the dental mirror can be used to manufacture the dental mirrors. Materials can be poured or injected into the mold and allowed to set to form the dental mirror. In other configurations, the dental mirror is cut, trimmed, or punched from a larger piece of material. Preferably, a punch that is operative to cut-out a plurality of dental mirrors from a sheet of material is used. One skilled in the art given the benefit of this disclosure will be able to select and design suitable methods for manufacturing the dental mirror disclosed here.

The mirrors and dental mirrors disclosed above and the methods disclosed for their production will be recognized by those skilled in the art to represent a significant technological advance. Robust mirrors and dental mirrors can be produced meeting precise characteristics, with advantageously low production costs and good production flexibility. In preferred embodiments, the dental mirrors have the advantageous attributes of small size, and simple and potentially inexpensive construction providing for single-use and disposability. Additional features and advantages will be understood from the following detailed description of certain preferred embodiments.

### BRIEF DESCRIPTION OF FIGURES

Certain preferred embodiments of the invention will be described below with reference to the attached drawings in which:

FIG. 1 is a top view of a dental mirror in accordance with preferred embodiments;

FIG. 2 is a side view of the ergonomic features of the shaft of a dental mirror in accordance with preferred embodiments;

FIGS. 3a-3d are schematics of various shapes and geometries that a mirror-head portion may comprise in accordance with preferred embodiments;

FIG. 4 is a side view of a dental mirror in accordance with preferred embodiments;

FIG. 5 is a side view of a flexible dental mirror in accordance with preferred embodiments; and

FIGS. 6a and 6b are schematics of a dental mirror comprising an indicator at a first temperature and a second temperature in accordance with preferred embodiments.

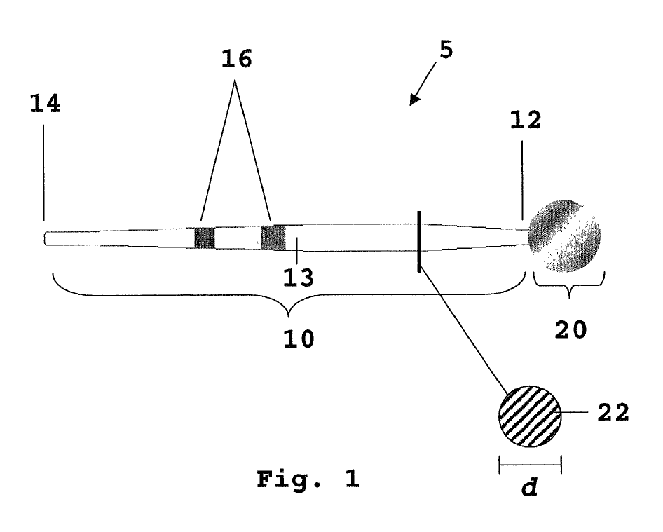

It will be apparent that the mirrors shown in FIGS. 1-6 are not necessarily to scale. Certain dimensions, such as the size of the mirror-head portion, may have been enlarged relative to other dimensions, such as the size of the handle, for clarity of illustration and ease of understanding. Directional references used in this disclosure and detailed description, and in the claims, refer to the orientation shown in FIG. 1 unless otherwise clear from context. It will be understood by those skilled in the art, that the dental mirrors disclosed here can be used generally in any orientation relative to gravity and/or a subject's mouth.

### DETAILED DESCRIPTION OF THE PREFERRED EMBODIMENT

It will be recognized from the above, that the novel mirrors disclosed here can be formed in innumerable different configurations and sizes. The precise size and configurations of the mirror-head portion and handle portion, including the choice of materials, geometries, shapes and the like will depend in large part on the particular application and use environment for which it is intended. For convenience, the particular embodiments of mirrors described in this more detailed description of certain preferred embodiments will generally be of a type suitable for use in the performance of oral examinations, oral surgery and other dental procedures. It will be within the ability of those skilled in the art, however, given the benefit of this disclosure, to select suitable materials and designs, as well as suitable manufacturing techniques, for production of disclosed mirrors suitable for these and other types of applications.

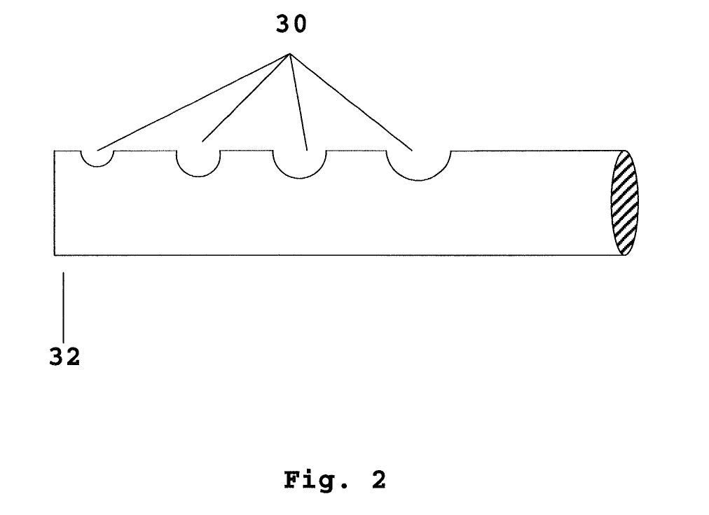

In accordance with certain preferred embodiments, and referring now to FIG. 1, a dental mirror 5 is seen to comprise a handle portion 10 unitary with a mirror-head portion 20. The handle portion 10 typically has a proximal or first end 12, an elongate shaft 13 and a distal or second end 14. As used here, the term proximal end or first end refers to the end of the handle portion, e.g. the shaft, closest to the mirror-head portion. The term distal or second end refers to the end of the handle portion furthest away from the mirror-head portion. The mirror-head portion 20 is permanently fixed to the handle portion 10 at first end 12 such that there exists a smooth and continuous surface from the first end 12 of the handle portion 10 to the mirror-head portion 20. The shaft 13 typically comprises one or more ergonomic features, such as those described above, that facilitate comfortable handling of the dental mirror during oral examinations, oral surgery, etc. Such ergonomic features include but are not limited to depressions, ridges, indentations, etc., that allow fitting of an operator's hands to the shaft of the dental mirror. For example, referring to FIG. 2, the shaft may have depressions 30 which receive the fingers of an operator. The ergonomic features may have numerous sizes as the size of the operator's fingers may vary, and typically the ergonomic features are located closer to the distal or second end 32 of the handle. In alternative embodiments, an ergonomic rubber sleeve can be slipped over the distal or second end 14 of the handle portion 10 (see FIG. 1) to provide for ergonomic grasping of the shaft 13. One skilled in the art given the benefit of this disclosure will be able to select suitable ergonomic features.

In accordance with certain preferred embodiments, the dimensions and cross-sectional shapes of the handle can vary. For example, the inset of FIG. 1 shows an elongate shaft having a circular cross-sectional shape 22 with a cross-sectional diameter d. Additionally, the length and width of the handle may also be variable but preferably is of a sufficient length and width to be held in the hand of an operator, e.g. a dentist or oral surgeon. The handle is preferably tapered, e.g. the cross-sectional diameter of the handle at the first and second ends is less than the cross-sectional diameter at the center of the elongate shaft. In preferred embodiments, the length of the handle portion is about 4-8 inches, e.g. about 6±0.5 inches, and the width of the handle portion is about 0.2-0.5 inches, e.g. about 0.3±0.05 inches at its largest point. In certain embodiments, the handle portion is hollow to provide for a lightweight dental mirror. One skilled in the art given the benefit of this disclosure will be able to select suitable lengths, widths, and cross-sectional shapes for the handle portion of the dental mirror.

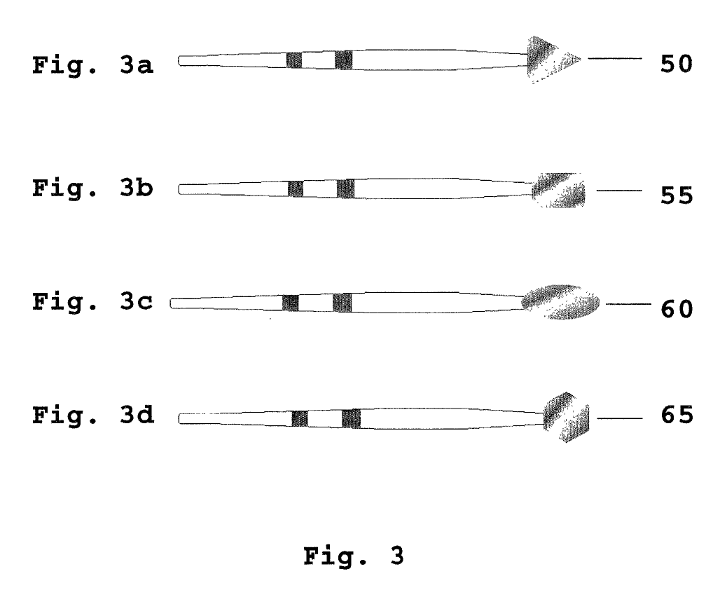

In accordance with certain preferred embodiments, the mirror-head portion of the dental mirror may comprise numerous different shapes. For example, the shape of the mirror-head portion may be generally circular (see e.g. mirror-head portion 20 in FIG. 1). Other shapes and configurations are possible. For example, referring to FIGS. 3a-3d, triangular mirror-head portion 50, rectangular mirror-head portion 55, elliptical mirror-head portion 60, and hexagonal mirror-head portion 65 may be substituted for circular mirror-head portion 20 shown in FIG. 1. One skilled in the art given the benefit of this disclosure will be able to select mirror head shapes suitable for an intended use of the mirror. The width of the mirror-head portion, at its largest point, is preferably less than about 1 inch. Because the mirror-head portion may comprise numerous shapes and geometries, the dimensions of the mirror-head portion may vary. For example, in embodiments comprising a circular mirror head, the diameter of the mirror-head portion is preferably less than about 1 inch, e.g. about 0.9±0.1 inches. Regardless of the shape of the mirror-head portion, preferably there are no jagged or sharp edges that might lacerate any portion of a subject's mouth. In embodiments comprising an equilateral triangular mirror-head portion, preferably each side is less than about 1 inch. The size and shape of the mirror-head portion is typically limited by an operator's ability to position the mirror head and view a desired region within a subject's mouth. One skilled in the art given the benefit of this disclosure will be able to select mirror-head portion dimensions, e.g. widths, heights, and or diameters, and shapes suitable for an intended use.

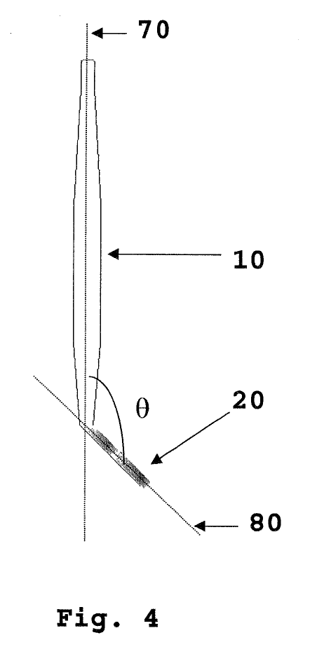

In accordance with certain preferred embodiments, the angle between the mirror-head portion and the handle portion may be variable. For example, referring to FIG. 4, the angle θ between the longitudinal axis 70 of the handle portion 10 and the longitudinal axis 80 of the mirror-head portion 20, i.e. the mirror head angle, is preferably equal to or greater than 90 degrees and less than 180 degrees. In certain procedures such angles provide for viewing of the mirror by the operator after insertion of the mirror into a subject's mouth. Preferred angles for the mirror head include 140 degrees, 150 degrees, 160 degrees, 170 degrees, and especially any angle between about 145 degrees and 165 degrees. One skilled in the art given the benefit of this disclosure will be able to select mirror head angles suitable for an intended use.

In accordance with certain preferred embodiments, the mirror-head portion of the dental mirror preferably comprises a reflective or mirror surface on both sides, e.g. the opposing or first and second faces, of the mirror-head portion. That is, the mirror-head portion provides a mirror surface on opposite sides of the mirror support structure. Preferably a rim does not surround the mirror surfaces, e.g. the mirror head is rimless. That is, the mirror surfaces are substantially smooth and substantially covers the first and second faces of the mirror-head portion. In certain embodiments, the mirror surface covers all surfaces of the mirror-head portion, e.g. the mirror surfaces envelope the entire mirror support structure. Such encompassing mirror surfaces typically increase the overall light levels within a subject's mouth. Furthermore, there exists no absolute requirement that the mirror surfaces be limited exclusively to the mirror-head portion. In certain embodiments (discussed below) where the mirror surfaces are disposed on or deposited on the mirror-head portion, the mirror surfaces may extend beyond the mirror-head portion and onto the handle portion, e.g. onto the proximal or first end of the handle portion. Regions of the mirror surface that extend beyond the mirror-head portion may also be used as a reflective surface and typically increase the overall light level within a subject's mouth. One skilled in the art given the benefit of this disclosure will be able to design mirror-head portions having mirror surfaces on both sides of the mirror-head portion.

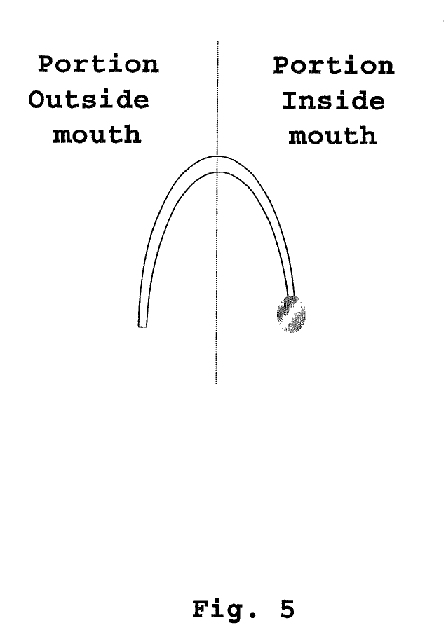

In accordance with certain preferred embodiments, the dental mirror can be manufactured from disposable materials such as plastics, rubbers, papers, and the like. Preferably, the materials are resistant to breaking under jaw pressure. That is, preferably the materials are capable of withstanding jaw closure on the handle portion and/or mirror-head portion of the mirror without breaking or fracturing the mirror surfaces or the handle portion. Also, preferably the materials are not excessively hard such that damage to teeth results if a subject bites down on the mirror-head portion or the handle portion. In certain embodiments the materials are capable of receiving a coloring agent, e.g. a dye or paint, to alter the appearance of the handle portion, e.g. to color the handle portion for a more pleasing and aesthetic appearance. Such colored mirrors may be especially useful for dental procedures involving children. Optionally, the handle portion and the mirror-head portion can be coated with flavoring to provide for a pleasant taste, e.g. fruit-flavored, bubble-gum flavored and the like. In other embodiments, the dental mirror comprises a handle portion manufactured from a flexible and bendable material for attachment to a subject's mouth, e.g. the shaft may be bent into a U-shape for use of the dental mirror (positioning the mirror head inside the mouth) without requiring manual grasping by the operator (see FIG. 5). Such bendable dental mirrors provide for removable attachment to a subject's mouth without the need for clamps or tape. One skilled in the art given the benefit of this disclosure will be able to originally form or subsequently bend the shafts of the dental mirrors into suitable configurations for removable attachment to a subject's mouth.

In accordance with certain preferred embodiments, the mirror surfaces may be deposited, or otherwise attached to the mirror-head portion, using well-known techniques for depositing reflective metal films and coatings onto a substrate, such as the mirror support structure. Suitable deposition techniques for depositing the mirror surfaces are well known to those skilled in the art and include but are not limited to vapor deposition techniques such as directed vapor deposition, chemical vapor deposition, etc. Suitable deposition materials include silver, aluminum, titanium, rhodium, and mixtures of any of these metals that provide a reflective surface after deposition onto a substrate. In certain embodiments, the mirror surfaces are painted on using reflective paints having a mirror finish or the mirror-head portion is dipped into reflective paints having a mirror finish. Suitable reflective paints are available from several manufacturers including Sherwin-Williams, Inc. (Cleveland, Ohio). One skilled in the art given the benefit of this disclosure will be able to select suitable reflective materials for coating onto the mirror-head portion to create one or more mirror surfaces.

In accordance with preferred embodiments, after deposition, or attachment, of the mirror surfaces to the mirror-head portion, the mirror surfaces can be coated with an antifog coating or film. That is, an anti-fog coating or film may be disposed on, brushed on, coated on, sprayed on, deposited on, etc., the mirror surfaces to prevent build-up of unwanted condensation that may inhibit or deter from viewing the mirror surfaces. Suitable anti-fogging agents and coatings are well known to those skilled in the art and include but are not limited to those manufactured by Hydromer Inc. (Poland) and Vista-Clear® manufactured by Amcon Laboratories (St. Louis, Mo.). Such anti-fog coatings may be FOOD GRADE or INDUSTRIAL GRADE coatings depending on the intended use of the dental mirror. Other suitable anti-fog coatings are described in U.S. Pat. No. 4,467,073 and U.S. Pat. No. 4,847,324, the entire disclosure of each of which is hereby incorporated herein by reference for all purposes. Preferably the anti-fog coatings are non-toxic and resistant to leaching from the mirror-head portion. One skilled in the art given the benefit of this disclosure will be able to select and deposit suitable anti-fog coatings onto the mirror-head portion of the dental mirror described here.

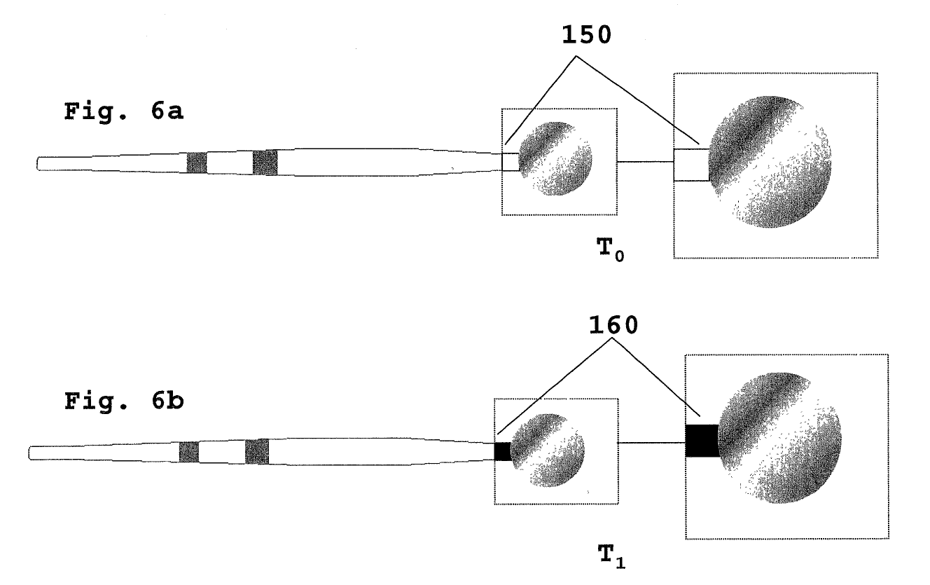

In accordance with certain preferred embodiments, sensors or indicators may be attached to the mirror to indicate that the mirror has been used. That is, an indicator that changes color may be attached to the handle portion and/or mirror-head portion of the mirror, for example, after the dental mirror has been placed into a subject's mouth. The indicator is typically added to dental mirrors to indicate that the dental mirror has been used and, thus, should be disposed of appropriately. The indicator thus can prevent an operator from using the dental mirror on more than one subject. For example, a temperature indicator strip, such as those manufactured by Tempco (Wood Dale, Ill.) and Reatec AG (Zurich, Switzerland), may be attached to the proximal or first end of the handle portion such that the indicator changes conditions or states after the mirror-head portion is inserted into or near the mouth of a subject. For example, referring to FIG. 6a, an indicator 150 may comprise a first color, e.g. white, prior to insertion into a subject's mouth. That is, the indicator preferably has a first color at a first temperature T₀, e.g. room temperature. After insertion into a subject' mouth, the indicator can change color, e.g. from white to black (see indicator 160 in FIG. 6b), in response to the increase in the temperature from T₀ to T₁. Other sensors are possible including but not limited to humidity sensors and the like. The indicators may be attached using an adhesive, rubber bands, two-sided tape, or other suitable devices for attachment of indicators to the mirror. One skilled in the art given the benefit of this disclosure will be able to select suitable indicators for informing a user that the dental mirror has been used.

Suitable manufacturing techniques using the materials discussed above, and other materials, will be apparent to those skilled in the art given the benefit of this disclosure. In certain embodiments, a mold or die is used to create the unitary handle portion and mirror-head portion. That is, materials such as plastic or rubber may be poured into or injected into a mold having the shape and dimensions of the mirror. The mirror head angle may be adjusted after the materials have hardened by reheating the proximal or first end of the handle portion and bending the mirror-head portion to a desired mirror head angle. In other embodiments, the handle portion of the dental mirror can be extruded from heated plastic for example and the proximal or first end of the handle can be flattened or shaped to provide a suitable mirror-head portion. In additional embodiments, the handle portion and mirror-head portion are manufactured separately and are permanently attached using suitable methods. For example, the mirror-head portion may be permanently attached to the handle portion using an adhesive or by heating the proximal end of the handle portion and the mirror-head portion such that the handle portion and mirror-head portion become unitary. After forming the unitary handle portion and mirror-head portion, the mirror surfaces and anti-fog coatings may be disposed onto the mirror-head portion.

In accordance with other preferred embodiments, the unitary dental mirror may be manufactured from a sheet of material using a punch template. For example, a generally planar sheet of material, e.g. plastic, paper, rubber, and the like, can be used to manufacture a plurality of dental mirrors. A template having a plurality of cut-outs in the shape of the dental mirror can be used as a punch. That is, the template can be pressed onto and through the material, using a pneumatic press and the like, to create a plurality of dental mirrors comprising the shape of cut-outs. Subsequently, the dental mirrors can be sanded and/or polished to remove any sharp edges, and the mirror-head portions can be angled (discussed above) and mirror surfaces can be deposited onto the mirror heads to create the two-sided unitary dental mirrors. One skilled in the art given the benefit of this disclosure will be able to select suitable methods for manufacturing a plurality of dental mirrors in a rapid and inexpensive manner.

Other suitable manufacturing techniques, such as injection molding, using plastic materials and the like, may be used to form the mirrors described here. In certain embodiments, a reinforcing member is added to the elongate shaft of the handle portion to provide for increased rigidity and to prevent breaking or fracturing of the elongate shaft. Suitable reinforcing members will be readily apparent to those skilled in the art given the benefit of this disclosure and include, but are not limited to, hard plastics, rubbers, papers, and the like.

Although the present invention has been described above in terms of specific embodiments, it is anticipated that other uses, alterations and modifications thereof will become apparent to those skilled in the art given the benefit of this disclosure. It is intended that the following claims be read as covering such alterations and modifications as fall within the true spirit and scope of the invention. It is intended that the articles “a” and “an”, as used below in the claims, cover both the singular and plural forms of the nouns which the articles modify.

What is claimed is:

1. A hand-held two-sided mirror comprising:
a mirror-head portion comprising a substantially planar first face and a substantially planar second face facing substantially opposite the first face;
a first reflective material on the first face and a second reflective material on the second face; and
a handle portion comprising an elongate shaft configured for hand manipulation of the position and orientation of the mirror-head portion, the mirror-head portion being at an obtuse angle to the longitudinal axis of the elongate shaft, and the mirror-head portion and elongate shaft being unitary with each other.

2. The hand-held two-sided mirror of claim 1 wherein the elongate shaft has at least one ergonomic feature.

3. The hand-held two-sided mirror of claim 2 wherein the elongate shaft has ergonomic features including at least rough surfaced indents sized and positioned to receive fingertips for manipulation of the position and orientation of the mirror-head portion.

4. The hand-held two-sided mirror of claim 1 wherein at least half of the elongate shaft has a cross-sectional area that tapers toward a free end opposite the mirror-head portion.

5. The hand-held two-sided mirror of claim 1 wherein at least half of the elongate shaft has a non-circular cross-sectional area.

6. The hand-held two-sided mirror of claim 1 wherein the elongate shaft is at least about 5 inches long.

7. The hand-held two-sided mirror of claim 1 wherein the mirror-head portion and the elongate shaft are a one-piece plastic molding.

8. The hand-held two-sided mirror of claim 7 wherein the plastic molding consists essentially of flexible plastic.

9. The hand-held two-sided mirror of claim 1 wherein the reflective material on the first face comprises a reflective coating on the first face of the mirror-head portion.

10. The hand-held two-sided mirror of claim 1 wherein the reflective material on the first face comprises a vapor deposition coating on the first face of the mirror-head portion.

11. The hand-held two-sided mirror of claim 1 wherein the reflective material on the first face comprises a dip-coating on the first face of the mirror-head portion.

12. The hand-held two-sided mirror of claim 1 wherein the reflective material on the first face comprises reflective paint.

13. The hand-held two-sided mirror of claim 1 wherein the mirror-head portion is a rimless mirror-head portion and the reflective material on the first face and the second face are unitary with each other, being portions of an all-over mirror coating on the mirror-head.

14. The hand-held two-sided mirror of claim 1 wherein the reflective material on the first face and the reflective material on the second face independently comprise silver, aluminum, rhodium or a mixture of any of them.

15. The hand-held two-sided mirror of claim 1 wherein the reflective material on the first face has an anti-fog coating.

16. The hand-held two-sided mirror of claim 1 wherein the first face is curvo-planar.

17. The hand-held two-sided mirror of claim 1 wherein the first face is concave or convex.

18. The hand-held two-sided mirror of claim 1 wherein the first mirror surface lies substantially in a plane at an angle of 150-170 degrees to the longitudinal axis of the elongate shaft.

19. The hand-held two-sided mirror of claim 15 comprising a clear sealant on the anti-fog material.

20. A two-sided dental mirror comprising:
a mirror-head portion comprising a substantially planar first face and a substantially planar second face facing substantially opposite the first face;
a first mirror surface comprising reflective material coated onto the first face and a second mirror surface comprising reflective material coated onto the second face; and
a handle portion comprising a first end, a second end and an elongate shaft configured for hand manipulation of the position and orientation of the mirror-head portion, the mirror-head portion being at an obtuse angle to the longitudinal axis of the elongate shaft, and the mirror-head portion and elongate shaft being unitary with each other.

21. The two-sided dental mirror of claim 20 wherein an all-over coating of reflective material covers the mirror-head portion.

22. The dental mirror of claim 1 wherein the first end comprises an indicator that is operative to change from an initial condition to a final condition in response to oral conditions.

23. The dental mirror of claim 22 wherein the indicator comprises a temperature strip.

24. The dental mirror of claim 23 wherein the temperature strip irreversibly changes color in response to an increase in temperature.

25. The dental mirror of claim 24 wherein the temperature strip irreversibly changes color at temperatures above or equal to about 37° C.

26. The dental mirror of claim 22 wherein the indicator comprises a humidity sensor.

27. A method of making a dental mirror comprising:
providing a dental mirror having a handle portion and a mirror-head portion, the handle-portion having a first end, an elongate shaft and a second end, the first end being attached to the mirror-head portion; and
disposing a coating onto the mirror-head portion to form mirror surfaces on first and second faces of the mirror-head portion.

28. The method of claim 27 wherein the coating is disposed simultaneously on all surfaces of the mirror head.

29. The method of claim 27 comprising plastic injection molding the dental mirror and coating all surfaces of the mirror-head portion with reflective material.

30. The method of claim 27 comprising inserting a reinforcing member into the handle portion.

31. The method of claim 27 wherein the mirror surfaces independently comprise silver, aluminum, rhodium or paint.

32. The method of claim 27 wherein the coating is disposed onto the mirror head using vapor deposition.

33. The method of claim 32 wherein the vapor deposition is chemical vapor deposition.

34. The method of claim 27 comprising disposing an anti-fog material on each of the mirror surfaces.

35. The method of claim 34 comprising disposing a sealant on the mirror surfaces comprising the anti-fog material.
